(19) United States
(12) Patent Application Publication
(10) Pub. No.: US 2004/0086006 A1
(43) Pub. Date: May 6, 2004

(54) Optical output stabilizing circuit and light transmission module of semiconductor laser

(75) Inventor: Sadao Tanikoshi, Kawasaki-shi (JP)

Correspondence Address: HOGAN & HARTSON L.L.P., 500 S. GRAND AVENUE, SUITE 1900, LOS ANGELES, CA, 90071-2611, US

(73) Assignee: Kabushiki Kaisha Toshiba

(21) Appl. No.: 10/426,222

(22) Filed: Apr. 30, 2003

(30) Foreign Application Priority Data
Nov. 6, 2002 (JP) 2002-322839

(51) Int. Cl. H01S 3/13

(52) U.S. Cl. 372/29.02

(57) ABSTRACT

An optical output stabilizing circuit is disclosed, which comprises a pilot signal generator, a pilot signal amplitude adjusting circuit which adjusts an amplitude of a pilot signal, a laser driving circuit which modulates a driving pulse current of a semiconductor laser by an output signal of the adjusting circuit, and drives the laser by the modulated driving current, a pilot signal detecting circuit which detects a detection voltage corresponding to the amplitude of the pilot signal, a first error amplifier which generates a difference signal by comparing the first detection voltage with a first reference voltage, and which, on the basis of the difference signal, controls the adjusting circuit, and a reference voltage temperature compensating circuit which carries out temperature compensation of the reference voltage of the first error amplifier to decrease fluctuation of an extinction ratio of the output beam of the laser at the high temperature operation time.

### CROSS-REFERENCE TO RELATED APPLICATIONS

This application is based upon and claims the benefit of priority from the prior Japanese Patent Application No. 2002-322839, filed Nov. 6, 2002, the entire contents of which are incorporated herein by reference.

### BACKGROUND OF THE INVENTION

1. Field of the Invention

The present invention relates to an optical output stabilizing circuit and a light transmission module of a semiconductor laser, and in particular, to a circuit for stabilizing the extinction ratio of a laser output beam when stabilization of temperature by a Peltier element or the like is not carried out with respect to the semiconductor laser, and for example, is used for a light transmission transmitter using a semiconductor laser incorporated into an optical fiber transmitting apparatus.

2. Description of the Related Art

In order to stabilize the extinction ratio of the output beam of a semiconductor laser, there are cases in which stabilization of temperature by a Peltier element or the like is carried out. However, on the other hand, in order to aim for the low electric power consumption and low cost, there are cases in which stabilization of temperature is not carried out.

When stabilization of temperature is not carried out, a conventional optical output stabilizing circuit which is used for appropriately controlling the bias current/driving pulse current of the semiconductor laser has an insufficient temperature compensating characteristic.

FIG. 6 shows a configuration of a light transmission module using a conventional optical output stabilizing circuit.

In the light transmission module, reference numeral 1 denotes a semiconductor module, reference numeral 2 denotes an analog adder circuit, reference numeral 3 denotes a variable gain amplifier, reference numeral 4 denotes a laser driving circuit, reference numeral 5 denotes a pilot signal generator, reference numeral 6 denotes a first reference voltage source, reference numeral 16 denotes a coupling capacitor, reference numeral 7 denotes a pilot signal amplifier, reference numeral 8 denotes a pilot signal detector, reference numeral 9 denotes a first error amplifier, and reference numeral 10 denotes a second error amplifier. A semiconductor laser element (LD) 12 and a photodiode (PD) 11 which detects the optical output power of the laser element are incorporated into the semiconductor laser module 1. Reference numeral 14 denotes a reference voltage adjusting resistor element, and reference numeral 15 denotes a variable resistor for adjusting the optical output power.

FIG. 7A and FIG. 7B show the temperature change characteristics of a general driving current to light emitting output (I-L) characteristic of the semiconductor laser, and the abscissas show the driving current (Current), and the ordinates show the optical output power (Optical power). FIG. 7A and FIG. 7B respectively show the I-L characteristics in a case in which the peripheral temperatures are 25° C. and 70° C.

In FIG. 7A and FIG. 7B, Threshold current is threshold current when the semiconductor laser starts to emit, and Slope efficiency is the amount of change ΔP of the optical output power with respect to the unit amount of change ΔI of the driving current, i.e., a slope efficiency ΔP/ΔI of the driving current to light emitting output (I-L) characteristic.

Hereinafter, the operations of the module shown in FIG. 6 will be described in detail with reference to FIG. 7A and FIG. 7B.

The pilot signal generator 5 generates a pulse signal of about 1 kHz, and generates a sine wave pilot signal due to the pulse signal being passed through, for example, a low pass filter. The pilot signal is superposed on the DC current at the analog adder circuit 2, and is inputted to the variable gain amplifier 3. The pilot signal included in the output of the analog adder circuit 2 is amplitude-adjusted by the variable gain amplifier 3, and is applied to the laser driving circuit 4.

The laser driving circuit 4 amplitude-modulates the high frequency pulse signal inputted from differential input terminals DATA+, DATA− by the output of the variable gain amplifier 3. The high frequency pulse signal amplitude-modulated by the pilot signal, i.e., the high frequency pulse current on which the pilot signal is superposed, and the DC bias current controlled by the output of the second error amplifier 10 are applied to the laser element 12.

As the result, the laser element 12 outputs an optical signal corresponding to the driving current on which the pilot signal component is superposed. The optical output signal is detected by the monitor photodiode 11. The pilot signal included in the detected output of the monitor photodiode 11 is inputted to the pilot signal amplifier 7 via the coupling capacitor 16, and is amplified, and is inputted to the pilot signal detector 8. A DC voltage output proportional to the amplitude of the pilot signal included in the detected output of the monitor photodiode 11 can be obtained from the pilot signal detector 8.

The first error amplifier 9 compares the outputted DC voltage from the pilot signal detector 8 and the first reference voltage from the first reference voltage source 6 via the reference voltage adjusting resistor element 14, and amplifies the differential voltages, and controls the gain of the variable gain amplifier 3 such that the differential voltage becomes 0 (zero). The current source of the laser driving circuit 4 is controlled by the output of the variable gain amplifier 3, and as the result, the driving pulse current of the laser element 12 outputted from the laser driving circuit 4 is controlled.

As described above, a slope efficiency (the driving current to light emitting output (I-L) characteristic shown in FIG. 7A and FIG. 7B) ΔP/ΔI corresponding to the magnitude of the amplitude of the detected pilot signal is measured, and the driving pulse current is increased by controlling the gain of the variable gain amplifier 3 so as to compensate for the decrease in the amplitude of the pilot signal at the time of high temperature operation on the basis of the measured result.

Further, the second error amplifier 10 compares the DC voltage of the detected output from the monitor photodiode 11 and the second reference voltage via the variable resistor 15 for optical output power adjustment, and amplifies the differential voltages, and controls the laser driving circuit 4 so that the optical output intensity of the laser element 12 becomes constant, and as the result, controls the DC bias current of the laser element 12 outputted from the laser driving circuit 4.

FIG. 8 is a graph showing the driving current to light emitting output (I-L) characteristic used for explanation of the principles of operation in which control of the driving pulse current of the semiconductor laser is carried out by using a pilot signal in the optical output stabilizing circuit of FIG. 6.

As can be understood from FIG. 8, in the driving current (injection current I) to light emitting output (L) characteristic of the laser element 12, i.e., the I-L characteristic, ΔP/ΔI changes in accordance with the operating temperature (25° C. and 70° C. in FIG. 8), and the amplitude of the pilot signal included in the detected current of the monitor photodiode 11 changes.

FIG. 9 is a characteristic curve graph showing a state in which the driving current to light emitting output (I-L) characteristic is saturated at the time of high temperature operation in an actual semiconductor laser.

The I-L characteristic at the time of room temperature (25° C.) is a curve as shown at the left side in FIG. 9. However, the I-L characteristic at the time of high temperature (70° C.) is a curve as shown at the right side in FIG. 9, and the slope efficiency (ΔP/ΔI) becomes small. Namely, at the time of operating at the a high temperature, it is necessary to apply much more driving current in order to obtain the same optical output as in the case of room temperature.

On the other hand, in the laser driving circuit 4 in FIG. 6, as shown in FIG. 7A and FIG. 7B, the laser element 12 is driven by a current in which the DC corresponding to the threshold current of the laser element 12 is superposed on the driving pulse current. The threshold current of the laser element 12 has a temperature characteristic, and the temperature characteristic increases at a high temperature.

In the optical output stabilizing circuit shown in FIG. 6, the output power of the laser element 12 detected by the monitor photodiode 11 is compared with the reference value at the second error amplifier 10, and the DC bias current applied to the laser element 12 is controlled such that the output power becomes a constant value.

In FIG. 7A, FIG. 7B, and FIG. 8, the slope of the driving current to light emitting output (I-L) characteristic at the threshold current or more, i.e., ΔP/ΔI of the laser element 12 of the threshold current or more, is constant without depending on the driving current made to flow at the laser element 12. However, in practice, as shown in FIG. 9, in particular, at the time of high temperature operation, the trend that the ΔP/ΔI is saturated at the time of high current is shown, and a decrease in the ΔP/ΔI arises at the time of high current.

Accordingly, in the monitor photodiode 11 in the optical output stabilizing circuit shown in FIG. 6, since the amplitude of the pilot signal is detected so as to be even smaller at the time of high temperature operation, the pulse current is controlled so as to be made unnecessarily large at the time of high temperature operation.

There is the problem that the extinction ratio unnecessarily increases at the high temperature side, and the spectral linewidth of the laser element 12 increases, and a deterioration of the dispersion penalty characteristic (a deterioration in the receiving sensitivity when the optical signal obtained from the laser element 12 is actually transmitted several tens of km by an optical fiber) is brought about.

Further, in the pilot signal detector 7 in the optical output stabilizing circuit shown in FIG. 6, there is no problem if only the amplitude of the pilot signal can be detected. However, in practice, there is slight leakage of the high modulation signal component, and there are cases in which the pilot signal detector 7 improperly operates. In order to prevent such malfunction caused by the leakage, it is necessary for the amplitude of the pilot signal component superposed on the optical output signal to be made large to some extent (about 10%), and in accordance therewith, there is the problem that deterioration of the S/N of the transmission light and deterioration of the receiving sensitivity are brought about.

Note that an optical output stabilizing circuit of a semiconductor laser which controls the source of bias current in order to adjust a low level of an optical output signal of a semiconductor laser and which controls the source of pulse current in order to adjust a high level of the optical output signal, is disclosed in Jpn. Pat. Appln. KOKAI Publication No. 6-169125.

Further, a dual loop system control controlling both the bias current and the modulation current of a semiconductor laser on the basis of a-measured value directly fetched from a semiconductor laser module is disclosed in P. 154-159 of “Employing Dual-Loop System Control in an Optical Communication Laser Diode Driver” by Brian Russell and one other author, Design Wave Magazine, United States, Analog Device, Inc. August 2001.

As described above, in the conventional optical output stabilizing circuit of a semiconductor laser, there is the problem that excess pulse driving current flows due to the saturation of the driving current to light emitting output (I-L) characteristic at a high temperature of the semiconductor laser, and the extinction ratio unnecessarily increases at a high temperature.

Further, in a pilot signal detector in the conventional optical output stabilizing circuit of a semiconductor laser, it is necessary for the amplitude of the pilot signal component to be made large to some extent, and there is the problem that deterioration of the S/N of the transmission light and deterioration of the receiving sensitivity are brought about.

### BRIEF SUMMARY OF THE INVENTION

According to a first aspect of the present invention, there is provided an optical output stabilizing circuit comprising a pilot signal generator which generates a low frequency pilot signal to be superposed on a driving pulse current of a semiconductor laser; a pilot signal amplitude adjusting circuit which adjusts an amplitude of the pilot signal generated by the pilot signal generator; a laser driving circuit which modulates the driving pulse current of the semiconductor laser by an output signal of the pilot signal amplitude adjusting circuit, and drives the semiconductor laser by the modulated driving pulse current; a pilot signal detecting circuit which detects a detection voltage corresponding to the amplitude of the pilot signal, from a current detected by a light detecting element which receives an output beam of the semiconductor laser; a first error amplifier which generates a difference signal by comparing the detection voltage detected by the pilot signal detecting circuit with a first reference voltage, and which, on the basis of the difference signal, controls the pilot signal amplitude adjusting circuit so that the amplitude of the pilot signal detected by the pilot signal detecting circuit becomes constant; and a reference voltage temperature compensating circuit which carries out temperature compensation of the reference voltage of the first error amplifier to decrease fluctuation of an extinction ratio of the output beam of the semiconductor laser at the time of high temperature operation.

According to a second aspect of the present invention, there is provided a light transmission module comprising a semiconductor apparatus in which at least a pilot signal generator, a pilot signal amplitude adjusting circuit, a laser driving circuit, and a pilot signal detecting circuit are incorporated in a form of an integrated circuit; a semiconductor laser module which is disposed at an exterior of the semiconductor apparatus, and into which a semiconductor laser driven by an optical output stabilizing circuit and a light detecting monitor element which receives an output beam of the semiconductor laser are incorporated; and a reference voltage temperature compensating circuit exteriorly connected to the semiconductor apparatus.

According to a third aspect of the present invention, there is provided a light transmission module comprising a semiconductor apparatus in which at least a pilot signal generator, a pilot signal amplitude adjusting circuit, a laser driving circuit, and a pilot signal detecting circuit are incorporated in a form of an integrated circuit; a semiconductor laser module which is disposed at an exterior of the semiconductor apparatus, and into which a semiconductor laser driven by an optical output stabilizing circuit and a light detecting monitor element which receives an output beam of the semiconductor laser are incorporated; and a reference voltage temperature compensating circuit exteriorly connected to the semiconductor apparatus.

According to a fourth aspect of the present invention, there is provided an optical fiber transmitting apparatus into which a light transmission module is incorporated, comprising a semiconductor apparatus in which at least a pilot signal generator, a pilot signal amplitude adjusting circuit, a laser driving circuit, and a pilot signal detecting circuit are incorporated in a form of an integrated circuit; a semiconductor laser module which is disposed at an exterior of the semiconductor apparatus, and into which a semiconductor laser driven by an optical output stabilizing circuit and a light detecting monitor element which receives an output beam of the semiconductor laser are incorporated; and a reference voltage temperature compensating circuit exteriorly connected to the semiconductor apparatus.

### BRIEF DESCRIPTION OF THE SEVERAL VIEWS OF THE DRAWING

FIG. 1 is a circuit diagram of a light transmission module using an optical output stabilizing circuit according to a first embodiment of the present invention.

FIG. 2 is a circuit diagram of a light transmission module using an optical output stabilizing circuit according to a second embodiment of the present invention.

FIG. 3A to FIG. 3E are waveform charts showing operating examples of a synchronous type pilot signal detection circuit of the light transmission module in FIG. 2.

FIG. 4 is a circuit diagram of a light transmission module using an optical output stabilizing circuit according to a third embodiment of the present invention.

FIG. 5A to FIG. 5D are waveform charts showing operating examples of an analog switch and a low pass filter in FIG. 4.

FIG. 6 is a circuit diagram of a light transmission module using a conventional optical output stabilizing circuit.

FIG. 7A and FIG. 7B are graphs showing temperature dependency of a general driving current to light emitting output characteristic of semiconductor laser.

FIG. 8 is a graph showing driving current to light emitting output (I-L) characteristics used for explanation of the principles of carrying out control of the driving pulse current of a semiconductor laser by using a pilot signal in the optical output stabilizing circuit of FIG. 6.

FIG. 9 is a characteristic graph showing a state in which the driving current to light emitting output (I-L) characteristics is saturated when a semiconductor laser is actually operated at a high temperature.

### DETAILED DESCRIPTION OF THE INVENTION

Hereinafter, embodiments of the present invention will be described with reference to the accompanying drawings.

### FIRST EMBODIMENT

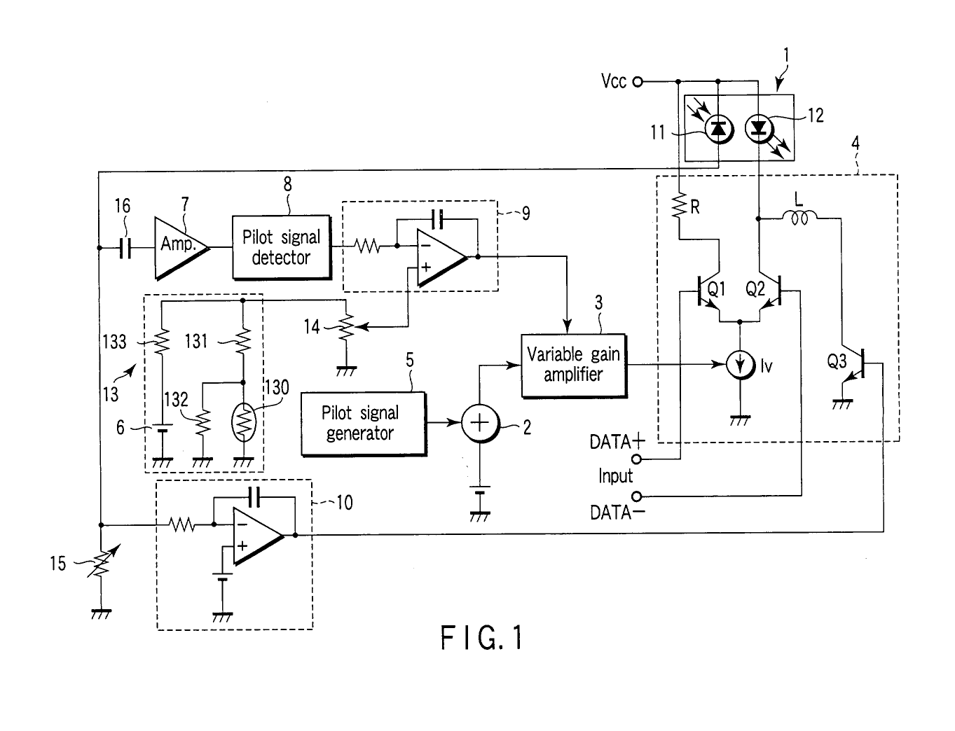

FIG. 1 shows a configuration of a light transmission module using an optical output stabilizing circuit according to a first embodiment of the present invention.

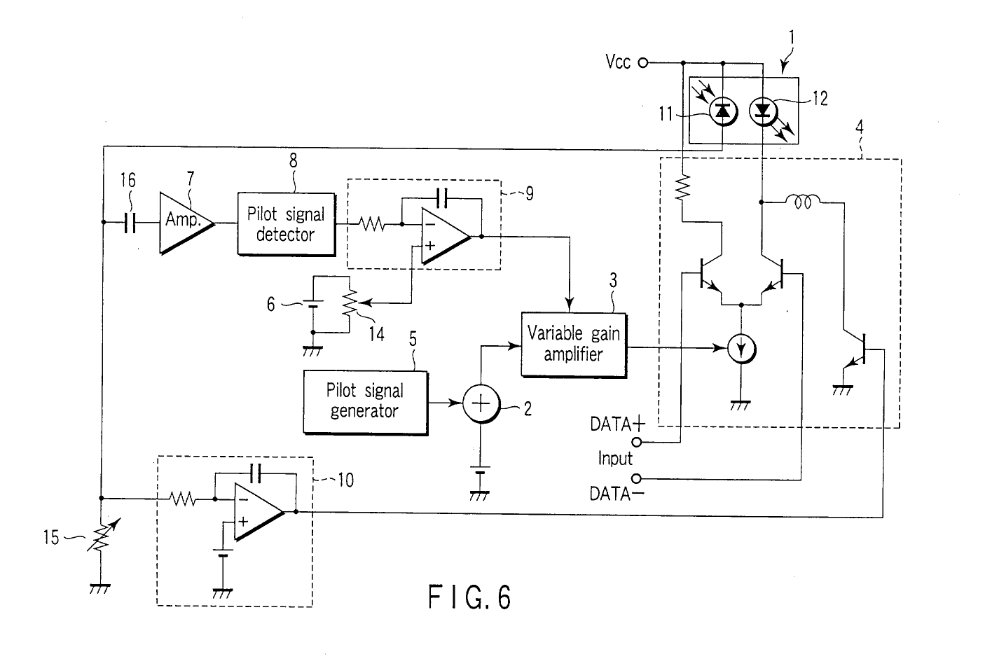

As compared with the light transmission module shown in FIG. 6, the light transmission module shown in FIG. 1 is different in that the fluctuation in the extinction ratio of the laser output beam at the time of high temperature operation is reduced by adding a temperature compensating circuit 13 carrying out temperature compensation of the reference voltage of a first error amplifier 9 (namely, the higher the temperature is, the lower the reference voltage is), and is the same with respect to the other parts or portions. Therefore, parts or portions which are the same as those in FIG. 6 are denoted by the same reference numerals.

In the light transmission module, a semiconductor laser element (LD) 12 and a monitoring light receiving element such as a photodiode (PD) 11 which detects the optical output power of the laser element are incorporated into the semiconductor laser module 1.

In the optical output stabilizing circuit, reference numeral 2 denotes an analog adder circuit, reference numeral 3 denotes a variable gain amplifier, reference numeral 4 denotes a laser driving circuit, reference numeral 5 denotes a pilot signal generator, reference numeral 6 denotes a first reference voltage source, reference numeral 16 denotes a coupling capacitor, reference numeral 7 denotes a pilot signal amplifier, reference numeral 8 denotes a pilot signal detector, reference numeral 9 denotes a first error amplifier, and reference numeral 10 denotes a second error amplifier. Reference numeral 14 denotes a reference voltage adjusting resistor element, and reference numeral 15 denotes a variable resistor for adjusting the optical output power.

The pilot signal generator 5 generates a pulse signal of about 1 kHz, and generates a sine wave pilot signal due to the pulse signal being passed through, for example, a low pass filter. The pilot signal is superposed on the DC current at the analog adder circuit 2, and is inputted to the variable gain amplifier 3. The pilot signal included in the output of the analog adder circuit 2 is amplitude-adjusted by the variable gain amplifier 3, and is applied to the laser driving circuit 4.

The laser driving circuit 4 comprises a pair of NPN transistors Q1 and Q2, a current source Iv, a load resistor element R, a choke coil L, and a bias controlling NPN transistor Q3. The pair of NPN transistors Q1 and Q2 have their emitters connected to each other and constitute a differential type input circuit. The current source Iv is connected to and between the emitter connection node of the pair of NPN transistors Q1 and Q2 and a ground node. The load resistor element R is connected to and between the collector of the transistor Q1 and a power supply node. The choke coil L is connected to and between the collector of the transistor Q2 and a ground node. The laser element 12 is connected to and between the collector of the transistor Q2 and the power supply node.

A high frequency pulse signal is inputted to the base of the pair of transistors Q1, Q2 via differential input terminals DATA+, DATA−, and the electric current of the current source Iv is controlled by the output of the variable gain amplifier 3, and the output of the second error amplifier 10 is applied to the base of the NPN transistor Q3 for controlling bias. As the result, the high frequency pulse signal inputted to the base of the pair of transistors Q1, Q2 is amplitude-modulated by a pilot signal included in the output of the variable gain amplifier 3. The high frequency pulse signal amplitude-modulated by the pilot signal, i.e., the high frequency pulse current on which the pilot signal is superposed, and the DC bias current controlled by the output of the second error amplifier 10 are applied to a laser element 12.

As the result, the laser element 12 outputs an optical signal corresponding to the driving current on which the pilot signal component is superposed. The optical output signal is detected by the monitor photodiode 11. The pilot signal included in the detected output of the monitor photodiode 11 is inputted to the pilot signal amplifier 7 via the coupling capacitor 16, and is amplified, and is inputted to the pilot signal detector 8. A DC voltage output proportional to the amplitude of the pilot signal included in the detected output of the monitor photodiode 11 can be obtained from the pilot signal detector 8.

The first error amplifier 9 compares the outputted DC voltage from the pilot signal detector 8 and the first reference voltage from the first reference voltage source 6 via the temperature compensation circuit 13 and the reference voltage adjusting resistor element 14, and amplifies the differential voltages, and controls the gain of the variable gain amplifier 3 such that the differential voltage becomes 0 (zero). The current source of the laser driving circuit 4 is controlled by the output of the variable gain amplifier 3, and as the result, the driving pulse current of the laser element 12 outputted from the laser driving circuit 4 is controlled.

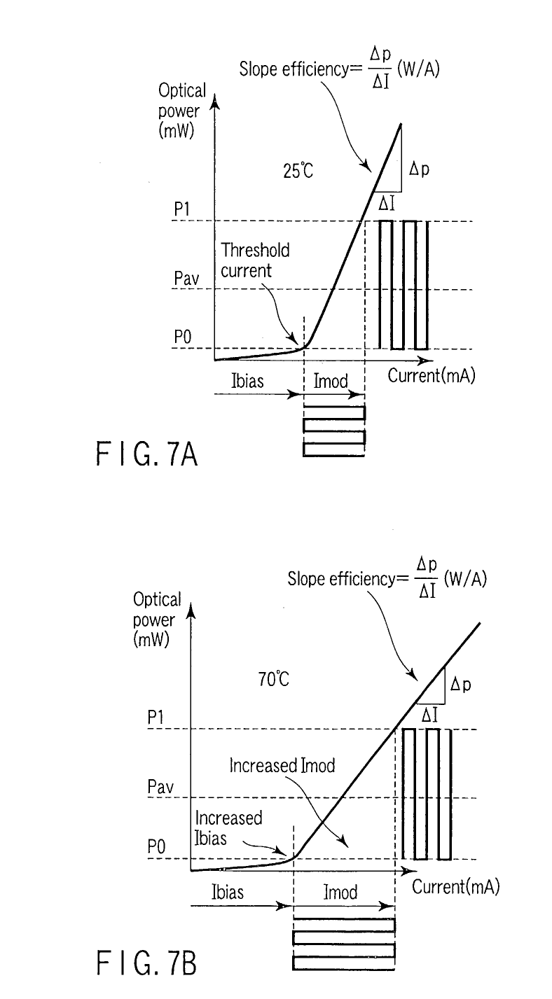

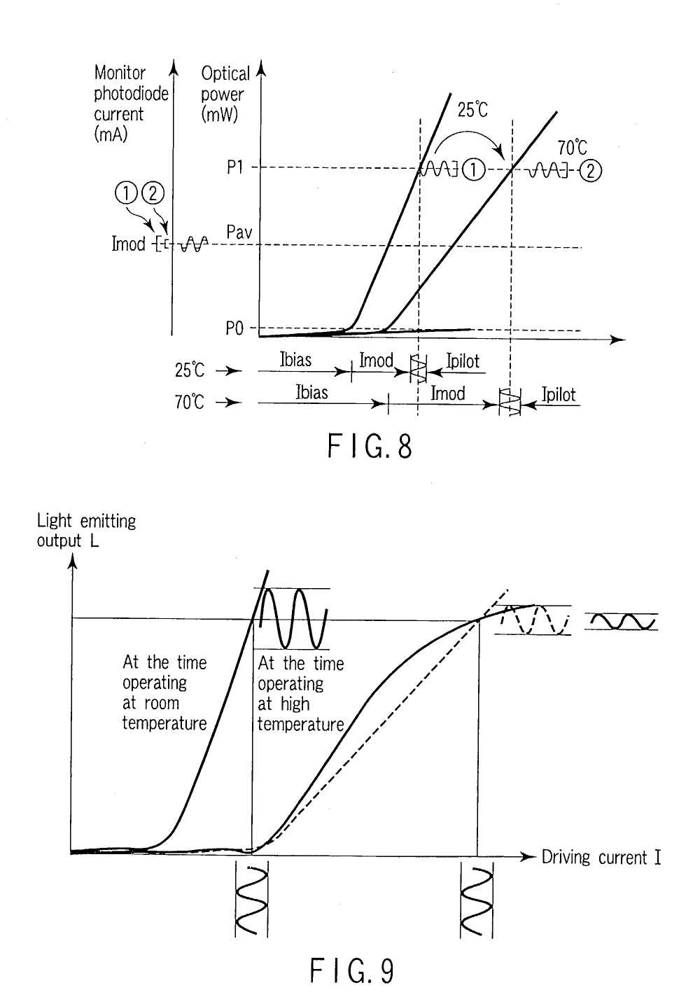

As described above, a slope efficiency (the driving current to light emitting output (I-L) characteristic shown in FIG. 7A and FIG. 7B) ΔP/ΔI corresponding to the magnitude of the amplitude of the detected pilot signal is measured, and the driving pulse current is increased by controlling the gain of the variable gain amplifier 3 so as to compensate for the decrease in the amplitude of the pilot signal at the time of high temperature operation on the basis of the measured result.

Further, the second error amplifier 10 compares the DC voltage of the detected output from the monitor photodiode 11 and the second reference voltage via the variable resistor 15 for optical output power adjustment, and amplifies the differential voltages, and controls the laser driving circuit 4 so that the optical output intensity of the laser element 12 becomes constant, and as the result, controls the DC bias current of the laser element 12 outputted from the laser driving circuit 4.

On the other hand, the temperature compensation circuit 13 is connected to and between the reference voltage source 6 and the reference voltage adjusting resistor element 14. The temperature compensation circuit 13 comprises a thermistor 130 and resistor elements 131, 132, and 133. The resistor element 133 is connected to the reference voltage source 6 in series. The thermistor 130 and the resistor element 131 are connected in series. The series-connected thermistor 130 and resistor element 131 are connected in parallel to the series-connected resistor element 133 and reference voltage source 6. The resistor element 132 is connected to the thermistor 130 in parallel.

The resistance value of the thermistor 130 decreases as the ambient temperature rises to a high temperature. Thus, the higher the temperature is, the lower the reference voltage applied to the error amplifier 9 via the temperature compensating circuit 13 and the reference voltage adjusting resistor element 14 from a reference voltage source 6 is. The resistor elements 131, 132, and 133 are inserted in order to compensate for the temperature coefficient at this time of the reference voltage applied to the error amplifier 9 in accordance with the temperature characteristic of the laser element 12.

Accordingly, the temperature compensating circuit 13 operates so as to reduce the pulse driving current at the time of high temperature. As the result, the flow of excess pulse driving current to the laser element 12 due to saturation of the driving current to light emitting output (I-L) characteristic can be suppressed at the time of high temperature operation. Therefore, the problem that the extinction ratio of the laser output beam unnecessarily increases is resolved.

The light transmission module shown in FIG. 1 comprises a semiconductor device in which the major parts of the optical output stabilizing circuit are integrated, a semiconductor laser module 1, and a reference voltage temperature compensating circuit exteriorly connected to the semiconductor apparatus. The major parts of the optical output stabilizing circuit comprises at least the pilot signal generator 5, the variable gain amplifier 3 which is a pilot signal amplitude adjusting circuit, the laser driving circuit 4, and a pilot signal detecting circuit 8 which is a pilot signal detector. The semiconductor laser module 1 is disposed at the exterior of the semiconductor apparatus, and comprises a semiconductor laser 12 driven by the optical output stabilizing circuit and an optical detecting monitor element 11 for receiving the output beam of the semiconductor laser. The reference voltage temperature compensating circuit comprises the thermistor 130, the resistor elements 131, 132, and 133. The light transmission module shown in FIG. 1 is incorporated into an optical fiber transmission apparatus.

In the light transmission module shown in FIG. 1, as compared with a conventional light transmission module, the reference voltage temperature compensating circuit is newly added and the compensating circuit is exteriorly connected to the semiconductor apparatus, and thus the light transmission module can be inexpensively realized.

### SECOND EMBODIMENT

By the way, when a general nonsynchronous detector is used as the pilot signal detector 8 in the first embodiment described above, the frequency component other than the pilot signal included in the output signal of a monitor photodiode 11 is detected, and there is the concern that the general nonsynchronous detector will operate incorrectly.

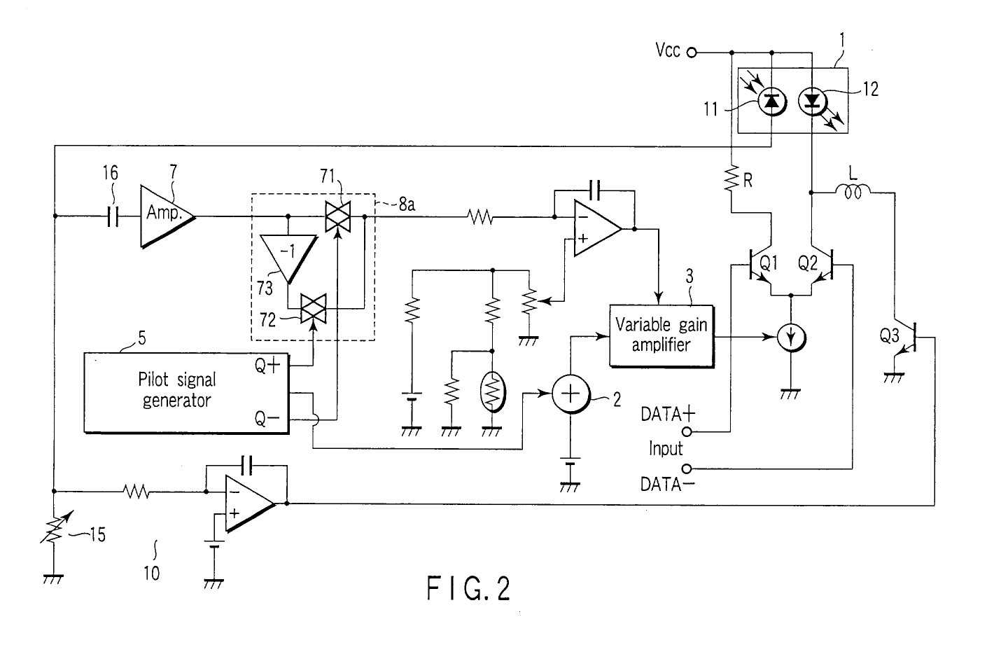

FIG. 2 shows a configuration of a light transmission module using an optical output stabilizing circuit according to a second embodiment of the present invention.

The light transmission module shown in FIG. 2 is different from the light transmission module shown in FIG. 1 in that a synchronous type pilot signal detector 8a is used as the pilot signal detector 8, and is the same with respect to the other parts or portions. Therefore, parts or portions which are the same as those in FIG. 1 are denoted by the same reference numerals.

The synchronous type pilot signal detector 8a comprises a full-wave rectifier formed from a pair of analog switches 71, 72, which are complementarily turned on/off by a clock signal synchronized with the pilot signal supplied from the pilot signal generator 5, and an inverting amplifier 73, which inverts the input to the analog switch 72.

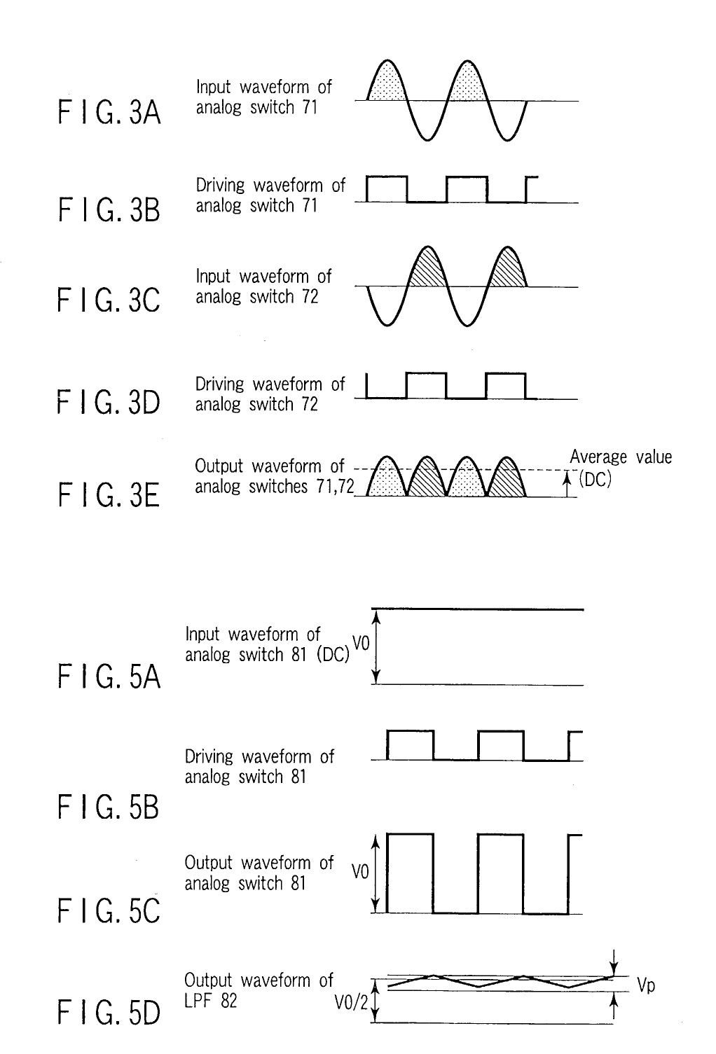

FIG. 3A to FIG. 3E show operating waveforms of the synchronous type pilot signal detector 8a of the light transmission module in FIG. 2. FIG. 3A shows an input waveform of the analog switch 71, FIG. 3B shows a drive waveform of the analog switch 71, FIG. 3C shows an input waveform of the analog switch 72, FIG. 3D shows a drive waveform of the analog switch 72, and FIG. 3E shows output waveforms of the analog switches 71 and 72.

The synchronous detecting circuit driven by a clock signal synchronized with a pilot signal detects only the pilot signal component included in the output signal of the monitor photodiode 11. Therefore, malfunctioning due to a transmission signal component included in the output signal of the monitor photodiode 11 can be prevented. As the result, the amplitude of the pilot signal component superposed on the optical output signal can be reduced, which contributes to an improvement of the transmitted light S/N and an improvement of the receiving sensitivity.

### THIRD EMBODIMENT

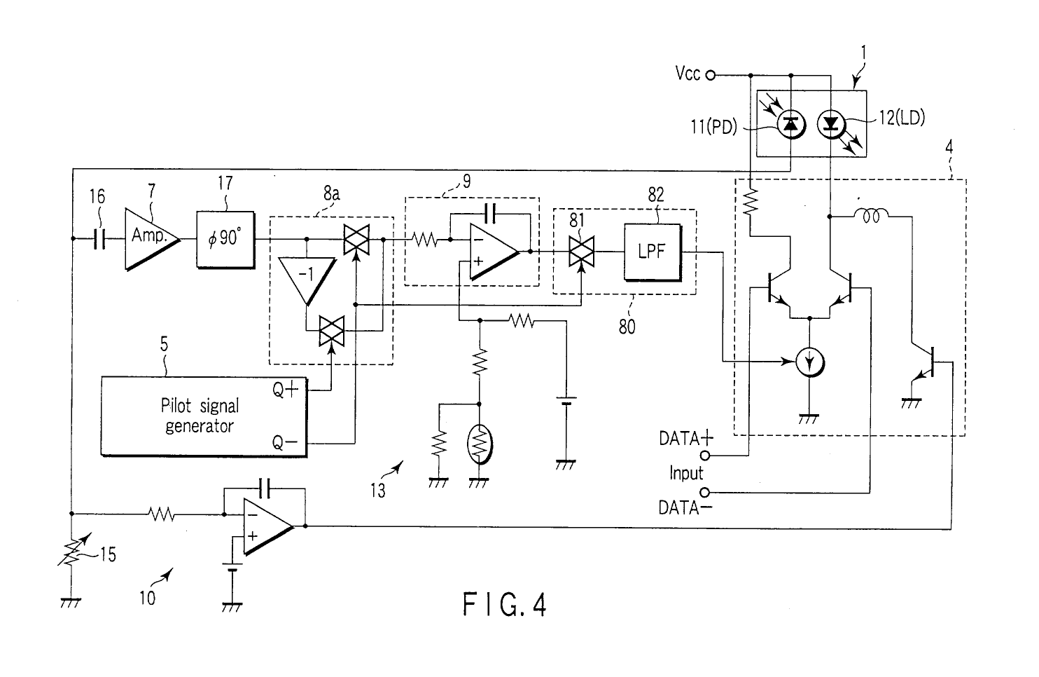

FIG. 4 shows a configuration of a light transmission module using an optical output stabilizing circuit according to a third embodiment of the present invention.

In the third embodiment, an example in which the control means of the laser driving pulse current by the pilot signal in the optical output stabilizing circuit in the first and second embodiments described above, is changed will be described.

As compared with the light transmission module shown in FIG. 1, the light transmission module shown in FIG. 4 uses a laser driving pulse current control circuit 80, in place of the combination of the analog adder circuit 2 and the variable gain amplifier 3. The laser driving pulse current control circuit 80 is formed from an analog switch 81 to which the output signal of the first error amplifier 9 is inputted, and which is turned on/off by a clock signal synchronized with the pilot signal supplied from the pilot signal generator 5, and a low pass filter (LPF) 82 to which the output signal of the analog switch 81 is inputted.

FIG. 5A to FIG. 5D show an example of waveforms of the analog switch 81 and the low pass filter LPF 82 in FIG. 4. FIG. 5A shows an input waveform (DC) of the analog switch 81, FIG. 5B shows a drive waveform of the analog switch 81, FIG. SC shows an output waveform of the analog switch 81, and FIG. SD shows an output waveform of the low pass filter (LFP) 82.

Given that the DC voltage (the output voltage of the first error amplifier 9) inputted to the analog switch 81 driven to be turned on/off by a clock signal synchronized with the pilot signal is V0, a pulse signal having amplitude V0 is outputted from the analog switch 81, and a signal, in which a pilot signal having a minute amplitude Vp is superposed with a DC voltage (V0/2), is outputted from the LPF 82 to which the pulse signal is inputted. In this case, the amplitude Vp of the pilot signal is determined in accordance with the cut-off frequency of the LPF 82, and is proportional to the input voltage V0 of the analog switch 81.

Such an operation is the same operation as in the combination of the analog adder circuit 2 and the variable gain amplifier 4, and there is no need to particularly use the variable gain amplifier 4. Therefore, it contributes to reduction in the number of parts and to making the light transmission module be low cost.

Note that a phase shifter 17 in FIG. 4 is inserted between a pilot signal amplifier 7 and a pilot signal detector 8 in order to compensate for the phase shift of the pilot signal in the LPF 82.

With the optical output stabilizing circuits of the respective embodiments described above, the problems of excess pulse driving current flowing due to by saturation of the driving current to light emitting output (I-L) characteristic at the time of high temperature of the semiconductor laser, and the extinction ratio of the laser output beam unnecessarily increasing, are resolved.

Further, in accordance with the optical output stabilizing circuits of the respective embodiments described above, even if stabilization of the temperature of the semiconductor laser is not carried out, the extinction ratio of the laser output beam can be maintained to be substantially a constant value in a broad range of peripheral temperatures, and it can contribute to the miniaturization and improved performance of a light transmitter.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical output stabilizing circuit comprising:
a pilot signal generator which generates a low frequency pilot signal to be superposed on a driving pulse current of a semiconductor laser;
a pilot signal amplitude adjusting circuit which adjusts an amplitude of the pilot signal generated by the pilot signal generator;
a laser driving circuit which modulates the driving pulse current of the semiconductor laser by an output signal of the pilot signal amplitude adjusting circuit, and drives the semiconductor laser by the modulated driving pulse current;
a pilot signal detecting circuit which detects a detection voltage corresponding to the amplitude of the pilot signal, from a current detected by a light detecting element which receives an output beam of the semiconductor laser;
a first error amplifier which generates a difference signal by comparing the detection voltage detected by the pilot signal detecting circuit with a first reference voltage, and which, on the basis of the difference signal, controls the pilot signal amplitude adjusting circuit so that the amplitude of the pilot signal detected by the pilot signal detecting circuit becomes constant; and
a reference voltage temperature compensating circuit which carries out temperature compensation of the reference voltage of the first error amplifier to decrease fluctuation of an extinction ratio of the output beam of the semiconductor laser at the time of high temperature operation.

2. An optical output stabilizing circuit according to claim 1, wherein the pilot signal detecting circuit comprises a synchronization detecting circuit.

3. An optical output stabilizing circuit according to claim 2, wherein the synchronization detecting circuit comprises a full wave rectifier which includes a pair of analog switches complementally turned on/off by a clock signal synchronized with the pilot signal supplied from the pilot signal generator.

4. An optical output stabilizing circuit according to claim 1, wherein the pilot signal amplitude adjusting circuit comprises:
an analog adder circuit which superposes the pilot signal on a DC voltage; and
a variable gain amplifier to which an output signal of the analog adder circuit is inputted and the difference signal of the first error amplifier is inputted, in which a gain of the variable gain amplifier is controlled by the difference signal of the first error amplifier to amplify an output signal of the analog adder circuit, an amplified output signal of the analog adder circuit being applied to the laser driving circuit to modulate the driving pulse current of the laser driving circuit.

5. An optical output stabilizing circuit according to claim 1, wherein the pilot signal amplitude adjusting circuit comprises:
an analog switch to which an output signal of the first error amplifier is inputted, and which is turned on/off by a clock signal synchronized with the pilot signal supplied from the pilot signal generator; and
a low pass filter to which a pulse signal outputted from the analog switch is inputted, and which converts the pulse signal into a signal in which a DC voltage and a pilot signal having an amplitude proportional to the DC voltage are superposed.

6. An optical output stabilizing circuit according to claim 1, wherein the reference voltage temperature compensating circuit comprises a thermistor as a temperature compensating element.

7. An optical output stabilizing circuit according to claim 1, further comprising:
an output beam power detecting circuit which detects an output beam power of the semiconductor laser from the current detected by the light detecting element; and
a second error amplifier which generates a difference signal by comparing a voltage corresponding to the output beam power detected by the output beam power detecting circuit with a second reference voltage, and which, on the basis of the difference signal generated by the second error amplifier, controls the laser driving circuit so that the output beam power detected by the output beam power detecting circuit becomes constant to control a DC bias current of the semiconductor laser.

8. An optical output stabilizing circuit according to claim 7, wherein the pilot signal detecting circuit comprises a synchronization detecting circuit.

9. An optical output stabilizing circuit according to claim 8, wherein the synchronization detecting circuit comprises a full wave rectifier which includes a pair of analog switches complementally turned on/off by a clock signal synchronized with the pilot signal supplied from the pilot signal generator.

10. An optical output stabilizing circuit according to claim 7, wherein the pilot signal amplitude adjusting circuit comprises:
an analog adder circuit which superposes the pilot signal on a DC voltage; and
a variable gain amplifier to which an output signal of the analog adder circuit is inputted and the difference signal of the first error amplifier is inputted, in which a gain of the variable gain amplifier is controlled by the difference signal of the first error amplifier to amplify an output signal of the analog adder circuit, an amplified output signal of the analog adder circuit being applied to the laser driving circuit to modulate the driving pulse current of the laser driving circuit.

11. An optical output stabilizing circuit according to claim 7, wherein the pilot signal amplitude adjusting circuit comprises:
an analog switch to which an output signal of the first error amplifier is inputted, and which is turned on/off by a clock signal synchronized with the pilot signal supplied from the pilot signal generator; and
a low pass filter to which a pulse signal outputted from the analog switch is inputted, and which converts the pulse signal into a signal in which a DC voltage and a pilot signal having an amplitude proportional to the DC voltage are superposed.

12. An optical output stabilizing circuit according to claim 7, wherein the reference voltage temperature compensating circuit comprises a thermistor as a temperature compensating element.

13. A light transmission module comprising:
a semiconductor apparatus in which at least a pilot signal generator, a pilot signal amplitude adjusting circuit, a laser driving circuit, and a pilot signal detecting circuit are incorporated in a form of an integrated circuit;
a semiconductor laser module which is disposed at an exterior of the semiconductor apparatus, and into which a semiconductor laser driven by an optical output stabilizing circuit and a light detecting monitor element which receives an output beam of the semiconductor laser are incorporated; and
a reference voltage temperature compensating circuit exteriorly connected to the semiconductor apparatus.

14. A light transmission module according to claim 13, Wherein the pilot signal detecting circuit comprises a synchronization detecting circuit.

15. A light transmission module according to claim 14, wherein the synchronization detecting circuit comprises a full wave rectifier which includes a pair of analog switches complementally turned on/off by a clock signal synchronized with the pilot signal supplied from the pilot signal generator.

16. A light transmission module according to claim 13, wherein the pilot signal amplitude adjusting circuit comprises:
an analog adder circuit which superposes the pilot signal on a DC voltage; and
a variable gain amplifier to which an output signal of the analog adder circuit is inputted and the difference signal of the first error amplifier is inputted, in which a gain of the variable gain amplifier is controlled by the difference signal of the first error amplifier to amplify an output signal of the analog adder circuit, an amplified output signal of the analog adder circuit being applied to the laser driving circuit to modulate the driving pulse current of the laser driving circuit.

17. A light transmission module according to claim 13, wherein the pilot signal amplitude adjusting circuit comprises:
an analog switch to which an output signal of the first error amplifier is inputted, and which is turned on/off by a clock signal synchronized with the pilot signal supplied from the pilot signal generator; and
a low pass filter to which a pulse signal outputted from the analog switch is inputted, and which converts the pulse signal into a signal in which a DC voltage and a pilot signal having an amplitude proportional to the DC voltage are superposed.

18. A light transmission module according to claim 13, wherein the reference voltage temperature compensating circuit comprises a thermistor as a temperature compensating element.

19. A light transmission module according to claim 13, further comprising:
an output beam power detecting circuit which detects an output beam power of the semiconductor laser from the current detected by the light detecting element; and
a second error amplifier which generates a difference signal by comparing a voltage corresponding to the output beam power detected by the output beam power detecting circuit with a second reference voltage, and which, on the basis of the difference signal generated by the second error amplifier, controls the laser driving circuit so that the output beam power detected by the output beam power detecting circuit becomes constant to control a DC bias current of the semiconductor laser.

20. A light transmission module comprising:
a semiconductor apparatus in which at least a pilot signal generator, a pilot signal amplitude adjusting circuit, a laser driving circuit, and a pilot signal detecting circuit are incorporated in a form of an integrated circuit;
a semiconductor laser module which is disposed at an exterior of the semiconductor apparatus, and into which a semiconductor laser driven by an optical output stabilizing circuit and a light detecting monitor element which receives an output beam of the semiconductor laser are incorporated; and
a reference voltage temperature compensating circuit exteriorly connected to the semiconductor apparatus.

21. An optical fiber transmitting apparatus into which a light transmission module is incorporated, comprising:
a semiconductor apparatus in which at least a pilot signal generator, a pilot signal amplitude adjusting circuit, a laser driving circuit, and a pilot signal detecting circuit are incorporated in a form of an integrated circuit;
a semiconductor laser module which is disposed at an exterior of the semiconductor apparatus, and into which a semiconductor laser driven by an optical output stabilizing circuit and a light detecting monitor element which receives an output beam of the semiconductor laser are incorporated; and
a reference voltage temperature compensating circuit exteriorly connected to the semiconductor apparatus.
